(19) United States
(12) Patent Application Publication
(10) Pub. No.: US 2024/0070039 A1
(43) Pub. Date: Feb. 29, 2024

(54) METHOD OF DEBUGGING NETWORK-ON-CHIP

(71) Applicant: SKYECHIP SDN BHD, Bayan Lepas (MY)

(72) Inventors: Yu Ying ONG, Bayan Lepas (MY); Chee Hak TEH, Bayan Lepas (MY); Soon Chieh LIM, Bayan Lepas (MY); Weng Li LEOW, Bayan Lepas (MY); Muhamad Aidil BIN JAZMI, Bayan Lepas (MY); Yeong Tat LIEW, Bayan Lepas (MY)

(21) Appl. No.: 17/938,810

(22) Filed: Oct. 7, 2022

(30) Foreign Application Priority Data
Aug. 24, 2022 (MY) PI2022004591

(51) Int. Cl. G06F 11/22; G06F 15/78

(52) U.S. Cl. CPC G06F 11/2273; G06F 15/7825

(57) ABSTRACT

The present invention relates to a method of debugging a targeted area or the whole network-on-chip (NOC) (101), whereby said targeted area or the whole NOC is triggered to enter into a freeze state before capturing of the state of the targeted area or the whole NOC (101) and unloading of the debug information, before finally said targeted area or the whole NOC is triggered to enter into an unfreeze state to allow forward progress to resume, using existing buffer storage, thus allowing user to debug and identify the source of issue without requiring a significant amount of extra storage.

### 1. TECHNICAL FIELD OF THE INVENTION

The present invention relates to a method of debugging a targeted area or the whole network-on-chip (NOC), whereby said targeted area or the whole NOC is triggered to enter into a freeze state before unloading of the debug information of the targeted area or the whole NOC, before finally said targeted area or the whole NOC is triggered to enter into an unfreeze state to allow forward progress to resume, using existing buffer storage, thus allowing user to debug and identify the source of issue without requiring a significant amount of extra storage.

### 2. BACKGROUND OF THE INVENTION

Network-on-chip's main functionality is to transmit packetized information within a system-on-chip (SoC), such as carrying write request and write data from a central processing unit (CPU) to a memory storage. Every NOC comprises of two basic components. The first basic component is node (105), which provides an interface for intellectual property (IP) blocks to access the network-on-chip (NOC). Interface protocols such as Advanced Microcontroller Bus Architecture Advanced eXtensible Interface (AMBA AXI) is converted into smaller NOC packets known as flits. The flits are then sent into the NOC network. Another basic component of the NOC is router, which is capable to connect with other routers (107) to establish a larger NOC topology (101), such as mesh topology, ring topology, or others. Each router is also capable to be connected to at least one node (105). The router is responsible for routing flits to the correct path via routing information deciphering.

FIG. 1 shows an example of an NOC topology (101) that is being connected to different IP blocks (103) such as CPU, peripheral component interconnect express (PCIe) and Memory Controller. These IP blocks (103) are connected to their respective nodes (105) via standard protocols such as Advanced Microcontroller Bus Architecture AXI Coherency Extensions (AMBA ACE) or Advanced Microcontroller Bus Architecture Advanced eXtensible Interface (AMBA AXI) protocol. NOC topology (101) is built using a combination of routers (107) and nodes (105). The routers (107) and nodes (105) are interconnected using links to enable transfer of flit across the NOC. In other words, a router (107) is connected to an adjacent router (107) or node (105) through a link interface. Each link interface between said router (107) or node (105) comprises of a pair of ingress interface and egress interface to support transfer of flit in both directions. The node (105) can also be connected to the Home node of the NOC via said AMBA ACE protocol.

FIG. 2 shows the ingress link and egress link within a router (107). Each router (107) can support multiple number of link pairs. Ingress link receives flit from adjacent egress link and sends credit to adjacent egress link. Egress link sends flit to adjacent ingress link and receives credit from adjacent ingress link. Egress link also arbitrates among all ingress links within router (107) (except its own ingress link).

FIG. 3 shows the ingress link and egress links within a node (105). Each node (105) only contains one link pair. Ingress link receives flit from adjacent egress link and sends credit to adjacent egress link. Egress link sends flit to adjacent ingress link and receives credit from adjacent ingress link.

Hence, it would be advantageous to alleviate the shortcomings by having a method of debugging a targeted area or the whole network-on-chip (NOC) which triggers said NOC to enter into a freeze state which prevents forward progress, before unloading the debug information of targeted area or the whole NOC using existing buffer storage, allowing user to debug and identify the source of issue without requiring a significant amount of extra storage.

### 3. SUMMARY OF THE INVENTION

Accordingly, it is the primary aim of the present invention to provide a method of debugging network-on-chip (NOC) allowing user to capture the state of the entire NOC, thus allowing the user to debug and identify the source of the issue without requiring a significant amount of extra storage.

It is yet another objective of the present invention to provide a method of debugging network-on-chip (NOC) which is scalable.

It is yet another objective of the present invention to provide a method of debugging network-on-chip (NOC) which allows access of debug information to a predetermined targeted NOC element or the whole NOC.

It is yet another objective of the present invention to provide a method of debugging network-on-chip (NOC) which affects minimum area utilization and performance impact to existing functional logic, by reusing existing buffer storages.

It is yet another objective of the present invention to provide a method of debugging network-on-chip (NOC) which allows flit manipulation during triggering of freeze state for debugging purpose.

It is yet another objective of the present invention to provide a method of debugging network-on-chip (NOC), wherein the freeze and unfreeze method does not cause functional failure or missing flits.

Additional objects of the invention will become apparent with an understanding of the following detailed description of the invention or upon employment of the invention in actual practice.

According to the preferred embodiment of the present invention the following is provided:

A method of debugging network-on-chip (NOC), comprising the following steps:
i. triggering said NOC to enter into a freeze state where forward progress is prevented;
ii. at least one NOC management unit unloading debug information of said NOC;
iii. triggering said NOC to enter into an unfreeze state to allow forward progress to resume.

In another embodiment of the invention there is provided:

A method of debugging network-on-chip (NOC), comprising the following steps:
i. triggering at least one predetermined NOC element in said NOC to enter into a freeze state where forward progress is prevented;
ii. at least one NOC management unit unloading debug information of said predetermined NOC element;
iii. triggering said predetermined NOC element to enter into an unfreeze state to allow forward progress to resume.

### 4. BRIEF DESCRIPTION OF THE DRAWINGS

Other aspect of the present invention and their advantages will be discerned after studying the Detailed Description in conjunction with the accompanying drawings in which:

FIG. 1 is an example of a network-on-chip (NOC) topology.

FIG. 2 is a block diagram showing the ingress link and egress link for a router in the NOC.

FIG. 3 is a block diagram showing the ingress link and egress link for a node in the NOC.

FIG. 4 shows a block diagram of an example of the process of triggering a broadcast freeze to the NOC.

FIG. 5 is a flow chart showing the sub-steps of unloading debug information of said NOC.

FIG. 6 shows a block diagram of an example of the process of configuring and debugging said NOC topology.

### 5. DETAILED DESCRIPTION OF THE DRAWINGS

In the following detailed description, numerous specific details are set forth in order to provide a thorough understanding of the invention. However, it will be understood by the person having ordinary skill in the art that the invention may be practised without these specific details. In other instances, well known methods, procedures and/or components have not been described in detail so as not to obscure the invention.

The invention will be more clearly understood from the following description of the embodiments thereof, given by way of example only with reference to the accompanying drawings, which are not drawn to scale.

The proposed debug methodology of the present invention allows user to capture the state of a predetermined targeted NOC element (105, 107) in the NOC, or the entire NOC, thus allowing the user to debug and root cause the source of the issue without requiring a significant amount of extra storage. One example is to debug a deadlock or livelock scenario, whereby the user will be able to pinpoint the source that causes the issue by tracing the debug information (flit, internal state, etc.) within the NOC. The proposed debug methodology is also scalable as said methodology does not rely on explicit additional blocks or storage other than those that already exist in the present NOC architecture. Hence, the growth in the number of routers (107)/nodes (105) needed when more IP blocks (103) need to communicate with each other will not change the NOC debug requirement as the debug mechanism is reusing the existing blocks and storage in the routers (107)/nodes (105).

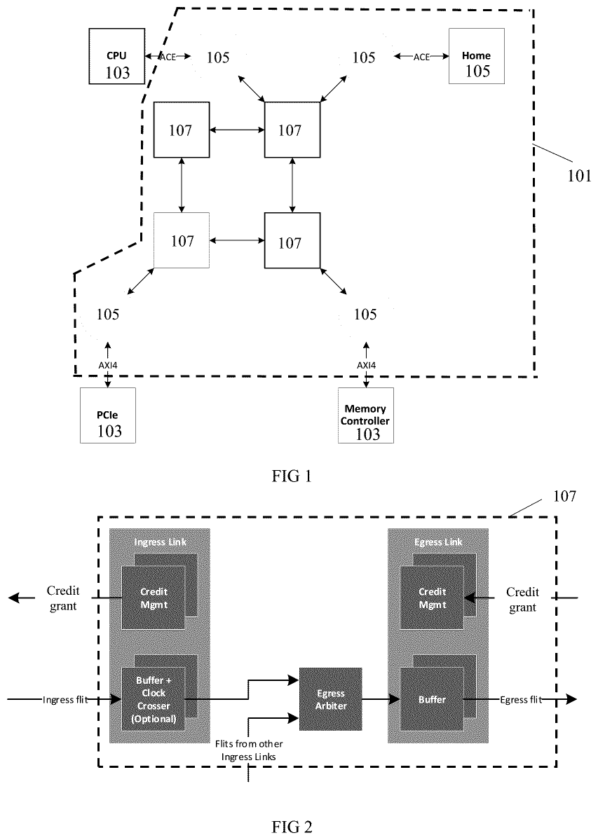

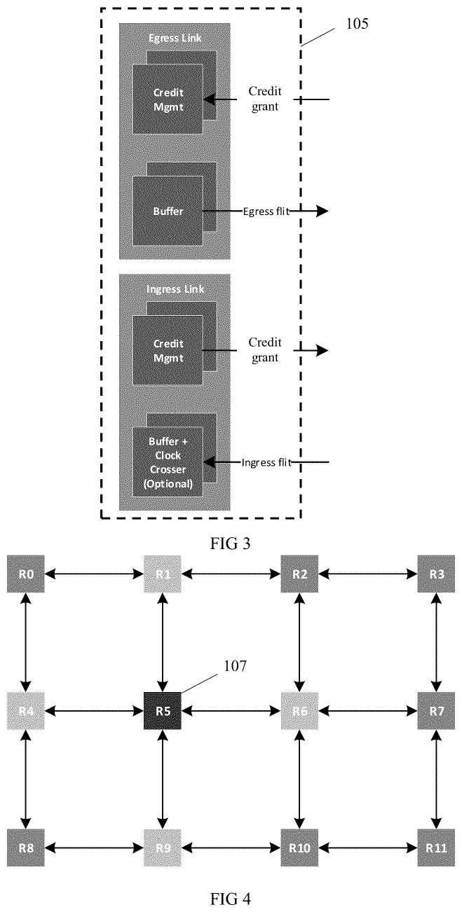

The first embodiment of the present invention is a method of debugging the whole network-on-chip (NOC), comprising the following steps. In step (i), the NOC (101) is triggered to enter into a freeze state where forward progress is prevented. For example, no more flits are being forwarded from egress link to the adjacent ingress link. This is to ensure that the flits of interest are captured and stored in the respective egress and ingress links' storage. Step (i) is done by at least one internal logic gating at least one clock causing an ingress link to stop sending at least one credit to adjacent egress link while said internal logic gating said clock causing an egress link to stop accepting new flits into said egress link's buffer. For routers (107), as shown in FIG. 2, said internal logic gating said clock to stop egress arbiter grant and to stop ingress credit management block from sending new credits to adjacent egress link. For nodes (105), as shown in FIG. 3, said internal logic gating said clock to stop accepting new flits through egress link from upstream logic and to stop ingress link credit management block from sending new credits to adjacent egress link.

The freeze state in step (i) can be triggered or originate from different sources. The freeze state can be triggered by at least one internal mechanism. Through the internal mechanism, the NOC management unit (601) needs to set up at least one trigger condition (such as timeout count value, match of a predefined flit pattern, or others) and the trigger is generated internally by any NOC element (105, 107) in said NOC (101) that meets at least one trigger condition set by said NOC management unit (601). The freezing is triggered to a predetermined or targeted NOC element (105, 107) (i.e., local freeze), before freezing is triggered to all NOC elements (105, 107) (i.e., broadcast freeze) in said NOC to stop forward progress. Step (i) can also be triggered by at least one external mechanism outside of said NOC (101), whereby freezing is triggered by said NOC management unit (601) to a predetermined/targeted NOC element (105, 107), or triggered to all NOC elements (105, 107) in said NOC (101) to stop forward progress. The mentioned NOC elements can be routers (107) or nodes (105).

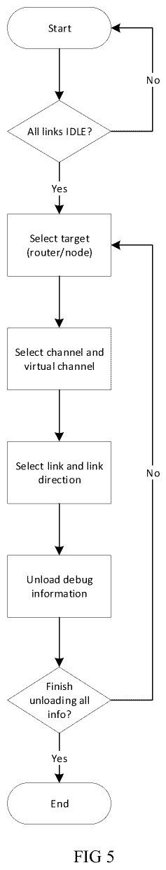

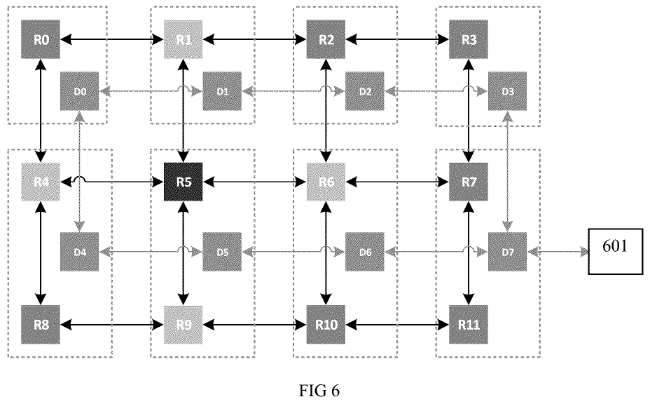

FIG. 4 shows an example of broadcast freeze to the NOC, whereby the initial freeze occurs at R5 router. The freeze at R5 router may be triggered internally by timeout action. Upon R5 router being frozen, R5 router stops sending new credit to the egress link of the adjacent routers (107) (R1, R4, R6 and R9). Adjacent routers (107) can continue to send flits to the R5 router until said R5 router's ingress link runs out of credits. R5 router also prevents new flits from being loaded into its egress buffer. Eventually, flit activity in R5 router will come to a halt and this behaviour will propagate outwards to other routers (107) (if there're continuous stream of flits). This is followed by a broadcast freeze to all NOC elements (routers (107) and nodes (105)) to ensure that all activities are halted, whereby said broadcast freeze is issued by an NOC management unit (601) via a configuration and debug NOC, after said NOC management unit (601) receives an interrupt from the R5 router. The freeze propagation occurs within the NOC in a graceful manner, whereby there is no abrupt stop that causes functional issue which might lead to information or state inaccuracy in said NOC. When the NOC is in a freeze state, the status, state or debug information of the NOC elements (105, 107) can be obtained. Examples of status, state or debug information of the NOC elements (105, 107) can be the ingress and egress buffer contents of each NOC element (105, 107) such as route information, flit. Other examples of status of the NOC elements (105, 107) can be the read and write pointers of the buffers in the NOC elements (105, 107), the ingress link requestors within the routers and others.

The method of the present invention may further comprise of a step of allowing user to perform flit manipulation for debug purpose, after step (i). For example, the content of a particular chosen flit can be swapped to alter the routing path, which can be done to debug if the current flit is the cause of a deadlock or livelock condition. After flit manipulation, NOC may be unfrozen to resume forward progress. User may check to see if there're any forward progress using the same debug flow at later time.

The NOC management unit (601) is connected to the configuration and debug NOC/configuration bus (CBUS) network via a CBUS master. In step (ii), the state or debug information of each NOC element (105, 107) is read out or unloaded by at least one NOC management unit (601) via said configuration and debug NOC. Step (ii) comprises of the following sub-steps, as shown in FIG. 5. In sub-step (a), upon ensuring all links within said NOC (101) are in idle state, selecting target NOC element (105, 107). In sub-step (b), selecting channel, virtual channel or combination thereof, that the user intends to monitor, observe or debug on. Dedicated or different buffer logic is used for each channel and virtual channel (i.e. total number of ingress buffer=number of channels x number of virtual channels). In sub-step (c), selecting link and link direction. In sub-step (d), unloading said debug information. Sub-steps (a), (b), (c) and (d) are repeated until a predetermined amount of debug information is unloaded from said NOC elements (105, 107). Debug information unloading process is done serially to reduce the amount of debug logic implementation, i.e. unload channel 0, virtual channel 1, followed by unload channel 0, virtual channel 1, and so on. All virtual channels are exhausted before unloading the next channel. Step (ii) can be done for debugging of the whole NOC or for targeted NOC elements (105, 107). For targeted NOC element debugging, the debug information of certain targeted NOC element (105, 107) may be unloaded. Debug information is unloaded from all the NOC elements (routers (107) or nodes (105)) in a serial manner to reduce area utilization and performance impact. Existing buffers and FIFO storages are reused without needing any extra storage for the purpose of debugging said NOC. Extra wires required to access information is also minimized. Debug information of the NOC elements (105, 107) refers to the state or status of the NOC elements (105, 107) that eventually is used for analysis and debugging.

Step (ii) of unloading the state of NOC element (105, 107) is performed using another second layer of configuration and debug NOC (D0, D1, D2, D3, D4, D5, D6, D7) that is independent of the existing first layer of NOC topology (101) as shown in Error! Reference source not found. Each NOC element (D0, D1, D2, D3, D4, D5, D6, D7) in the second layer configuration and debug NOC can be shared across multiple NOC elements (routers (107) or nodes (105)) in the first layer. For example, the D4 NOC element of the second NOC layer is shared between the R4 router and R8 router of the first NOC layer. A separate configuration and debug NOC is to ensure that the debug information can be unloaded successfully when the main NOC first layer is in a freeze state. The separate configuration and debug NOC is also used to configure or reconfigure the NOC for different mission mode operations.

In step (iii), said NOC (101) is triggered to enter into an unfreeze state to allow forward progress to resume, and further, to debug a subsequent sequence of events. Step (iii) is done by at least one internal logic ungating at least one clock causing an ingress link to resume the return of at least one outstanding credit to adjacent egress link while said internal logic ungating said clock causing an egress link to resume accepting new flits into said egress link's buffer. For routers (107), as shown in FIG. 2, said internal logic ungating said clock to allow egress arbiter to grant requests. For nodes (105), as shown in FIG. 3, said internal logic ungating said clock to resume acceptance of new flits through ingress link from upstream logic.

Apart from triggering a broadcast freeze which freezes the entire NOC (101), the debug methodology of the present invention also supports triggering targeted freeze as illustrated as the second embodiment of the present invention, whereby freeze state is triggered on at least one predetermined NOC element (107, 105) in said NOC (101). For example, a particular targeted router (107) is frozen to capture the current state, followed by triggering unfreeze of that targeted router (107) to resume operation. The method of debugging NOC (101) comprises of the following steps. In step (i), a predetermined NOC element (107, 105) in the NOC (101) is triggered to enter into a freeze state where forward progress is prevented. Step (i) is triggered by at least one external mechanism outside of said NOC (101), whereby freezing is triggered to a predetermined/targeted NOC element (105, 107) in said NOC (101), via the configuration and debug NOC, to stop forward progress. Step (i) is done by at least one internal logic gating at least one clock causing an ingress link to stop sending at least one credit to adjacent egress link while said internal logic gating said clock causing an egress link to stop accepting new flits into said egress link's buffer.

In step (ii), the state or debug information of said predetermined NOC element (105, 107) in said NOC (101) is read out or unloaded by said NOC management unit (601) via configuration and debug NOC. In step (iii), upon successful unload, said predetermined NOC element (105, 107) is triggered to enter into an unfreeze state to allow forward progress to resume. Step (iii) is done by at least one internal logic ungating at least one clock causing an ingress link to resume the return of at least one outstanding credit to adjacent egress link while said internal logic ungating said clock causing an egress link to resume accepting new flits into said egress link's buffer.

During implementation of debug methodology using targeted freeze of a predetermine NOC element (107, 105), the other unaffected NOC elements can continue their operations, if the flit for the unaffected NOC elements (105, 107) does not need to travel through the frozen NOC element (105, 107). If there are links trying to send flits to frozen NOC element (105, 107), the freeze operation causes temporary halt and operation is resumed after frozen NOC element (105, 107) is unfrozen with no flits being dropped during this process.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative only and other embodiments may be selected without departing from the scope of the present invention, as set forth in the claims appended hereto.

What is claimed is:

1. A method of debugging network-on-chip (NOC) (101), comprising the following steps:
i. triggering said NOC (101) to enter into a freeze state where forward progress is prevented;
ii. at least one NOC management unit (601) unloading debug information of said NOC (101);
iii. triggering said NOC (101) to enter into an unfreeze state to allow forward progress to resume.

2. A method of debugging network-on-chip (NOC) (101), comprising the following steps:
i. triggering at least one predetermined NOC element (105, 107) in said NOC (101) to enter into a freeze state where forward progress is prevented;
ii. at least one NOC management unit (601) unloading debug information of said predetermined NOC element (105, 107);
iii. triggering said predetermined NOC element (105, 107) to enter into an unfreeze state to allow forward progress to resume.

3. The method of debugging network-on-chip (NOC) as claimed in claim 1, wherein step (i) is done by at least one internal logic gating at least one clock causing an ingress link to stop sending at least one credit to adjacent egress link while said internal logic gating said clock causing an egress link to stop accepting new flits into said egress link's buffer.

4. The method of debugging network-on-chip (NOC) as claimed in claim 1, wherein step (i) is triggered by at least one internal mechanism, whereby said trigger is generated internally by any NOC element (105, 107) in said NOC (101) that meets at least one trigger condition set by said NOC management unit (601); wherein said freezing is triggered to a predetermined NOC element (105, 107), before freezing is triggered to all NOC elements (105, 107) in said NOC (101).

5. The method of debugging network-on-chip (NOC) as claimed in claim 1, wherein step (i) is triggered by at least one external mechanism outside of said NOC (101), whereby freezing is triggered by said NOC management unit (601) to a predetermined NOC element (105, 107), or to all NOC elements (105, 107) in said NOC (101).

6. The method of debugging network-on-chip (NOC) as claimed in claim 2, wherein step (i) is triggered by at least one external mechanism outside of said NOC (101), whereby freezing is triggered by said NOC management unit (601) to said predetermined NOC element (105, 107) in said NOC (101).

7. The method of debugging network-on-chip (NOC) as claimed in claim 1, wherein step (ii) comprises of the following sub-steps:
(a) upon ensuring all links within said NOC (101) are in idle state, selecting target NOC element (105, 107);
(b) selecting channel, virtual channel or combination thereof;
(c) selecting link and link direction;
(d) unloading said debug information;
wherein said sub-steps (a), (b), (c) and (d) are repeated until a predetermined amount of debug information is unloaded from said NOC elements (105, 107).

8. The method of debugging network-on-chip (NOC) as claimed in claim 1, wherein said method further comprises of a step of performing flit manipulation for debug purpose, after step (i).

9. The method of debugging network-on-chip (NOC) as claimed in claim 1, wherein step (iii) is done by at least one internal logic ungating at least one clock causing an ingress link to resume the return of at least one outstanding credit to adjacent egress link while said internal logic ungating said clock causing an egress link to resume accepting new flits into said egress link's buffer.

10. The method of debugging network-on-chip (NOC) as claimed in claim 2, wherein said NOC element is router (107) or node (105).

11. The method of debugging network-on-chip (NOC) as claimed in claim 1, wherein said debug information is state of at least one NOC element;
said state of NOC element comprising ingress and egress buffer contents comprising route information or flit;
read and write pointers of said buffer;
ingress link requestors within said NOC elements; or combination thereof.

12. The method of debugging network-on-chip (NOC) as claimed in claim 4, wherein trigger condition is timeout count value, match of a predefined flit pattern or combination thereof.
